(19) United States
(12) Patent Application Publication
(10) Pub. No.: US 2002/0111389 A1
(43) Pub. Date: Aug. 15, 2002

(54) Dimenssionally stable foam made from compatiblized blends of poly (vinly aromatic) polymers and poly (alpha-olefin) polymers for cushion packaging applications

(76) Inventors: Bharat I. Chaudhary, Pearland, TX (US); Lawrence S. Hood, Saginaw, MI (US); Russell P. Barry, St Jansteen (NL)

Correspondence Address: THE DOW CHEMICAL COMPANY, INTELLECTUAL PROPERTY SECTION, 2301 N BRAZOSPORT BLVD, FREEPORT, TX, 77541-3257, US

(21) Appl. No.: 09/929,781

(22) Filed: Aug. 14, 2001

Related U.S. Application Data
(60) Provisional application No. 60/225,111, filed on Aug. 14, 2000.

(51) Int. Cl. C08L 1/00

(52) U.S. Cl. 521/139

(57) ABSTRACT

Foams made from a ternary blend of an alkenyl aromatic polymer such as polystyrene, an α-olefin polymer such as polyethylene, and a substantially random interpolymer as compatibilizer, are used as cushion packaging. The cushion packaging foams are soft, dimensionally stable and exhibit good cushioning properties.

### CROSS-REFERENCE TO RELATED APPLICATIONS

This application claims the benefit of U.S. Provisional Application No. 60/225,111, filed on Aug. 14, 2000, the entire contents of which are herein incorporated by reference.

### STATEMENT REGARDING FEDERALLY SPONSORED RESEARCH OR DEVELOPMENT

The research and development leading to the subject matter disclosed herein was not federally sponsored.

### BACKGROUND OF THE INVENTION

This invention relates generally to flexible, dimensionally stable foam for use in a variety of applications, such as cushion packaging.

Foams for cushion packaging applications are typically made by expanding low density polyethylene (LDPE) with fast permeating blowing agents, and using permeability modifiers to alter the rate at which the blowing agent escapes from the cells of the foam after the foam is cooled. The loading of these permeability modifiers has to be controlled accurately to prevent excessive shrinkage or expansion of the foams. Furthermore, in many cases, the effectiveness of the permeability modifier changes significantly with storage temperature, making it necessary to cure the foam at controlled temperature and/or humidity (an expensive process). Some permeability modifiers are hydrophilic and attract moisture as they bloom to the surface of the foam. Excessive permeability modifier or moisture at the surface of the foam can cause problems in hot air fabrication. For these reasons, it is desirable to make foams that are substantially free of permeability modifiers, but which exhibit properties, such as density, softness, flexibility and cushioning, similar to that of LDPE foams.

Thus, it would be desirable to provide an alternative dimensionally stable foam for a variety of applications, including cushion packaging.

### BRIEF DESCRIPTION OF THE DRAWINGS

Not Applicable

### SUMMARY OF THE INVENTION

1. A soft, dimensionally stable foam comprising

(A) from about 25 to about 75% by weight of one or more alkenyl aromatic polymers;

(B) from about 25 to about 75% by weight one or more ethylene and or a-olefin homopolymers or copolymers; and

(C) from about 5 to about 50% by weight one or more substantially random interpolymers; comprising;

(1) from about 5 to about 65 mole percent of polymer units derived from;

(a) at least one vinyl or vinylidene aromatic monomer, or

(b) at least one hindered aliphatic or cycloaliphatic vinyl or vinylidene monomer, or

(c) a combination of at least one aromatic vinyl or vinylidene monomer and at least one hindered aliphatic or cycloaliphatic vinyl or vinylidene monomer, and

(2) from about 35 to about 95 mole percent polymer units derived from at least one of ethylene and/or a C₃₋₂₀ α-olefin; and

(3) optionally, polymer units derived from one or more of ethylenically unsaturated polymerizable monomers other than those derived from (1) and (2); and wherein

said soft foam has a density of from about 5 to about 110 kg per cubic meter and an Asker C hardness of less than about 65.

### DETAILED DESCRIPTION OF THE INVENTION

In this invention, a polymeric foam made from a blend of an alkenyl aromatic polymer and an α-olefin polymer may be used for cushion packaging applications. The blend also contains a polymeric compatibilizer for the alkenyl aromatic polymer and the α-olefin polymer.

Any numerical values recited herein include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated in this specification. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

All references herein to elements or metals belonging to a certain Group refer to the Periodic Table of the Elements published and copyrighted by CRC Press, Inc., 1989. Any reference to the Group or Groups shall be to the Group or Groups as reflected in this Periodic Table of the Elements using the IUPAC system for numbering groups.

Unless otherwise stated, all ranges include both endpoints and all numbers between the endpoints.

“Hydrocarbyl” means any aliphatic, cycloaliphatic, aromatic, aryl substituted aliphatic, aryl-substituted cycloaliphatic, aliphatic substituted aromatic, or aliphatic substituted cycloaliphatic groups. “Hydrocarbyloxy” means a hydrocarbyl group having an oxygen linkage between it and the carbon atom to which it is attached. “Aliphatic” means a compound having a straight- or branched-chain arrangement of its carbon atoms.

“Interpolymer” means a polymer having polymerized therein monomeric units derived from at least two different monomers. This includes copolymers, terpolymers and tetrapolymers. “Monomeric unit” refers to a polymer backbone portion that is derived from a single monomer.

“Soft foam” means a foam having an Asker C hardness of <65, preferably <60, more preferably <50 at a foam density of 110 kg/M³ or less (≦).

“Dimensionally stable foam” refers to a foam that exhibits a maximum volume change (increase or decrease) of 15 volume percent or less.

“Maximum Volume Change” refers to the maximum change in foam volume over time as the foam ages at about 23° C. (room temperature), referenced to the fresh volume measured when the foam first reaches a temperature of about 23° C. (i.e., fresh after manufacture).

Hardness measurements of the foams use an Asker C durometer for cellular rubber and yarn in accordance with ASTM D2240-97, but with a 5 mm diameter spherical indentor.

Alkenyl Aromatic Polymer

For purposes of this invention, an alkenyl aromatic polymer is a melt-processable polymer or melt processable impact-modified polymer in the form of polymerized vinyl aromatic monomers as represented by the structure:

H₂C═CRAr

wherein R is hydrogen or an alkyl radical that preferably has no more than three carbon atoms and Ar is an aromatic group. R is preferably hydrogen or methyl, most preferably hydrogen. Aromatic groups Ar include phenyl and naphthyl groups. The aromatic group Ar may be substituted. Halogen (such as Cl, F, Br), alkyl (especially C₁-C₄ alkyl such as methyl, ethyl, propyl and t-butyl), C₁-C₄ haloalkyl (such as chloromethyl or chloroethyl) and alkoxyl (such as methoxyl or ethoxyl) substituents are all useful. Styrene, para-vinyl toluene, α-methyl styrene, 4-methoxy styrene, t-butyl styrene, chlorostyrene, vinyl naphthalene and the like are all useful vinyl aromatic monomers. Styrene is especially preferred.

The alkenyl aromatic polymer may be a homopolymer of a vinyl aromatic monomer as described above. Polystyrene homopolymers are the most preferred alkenyl aromatic polymers. Interpolymers of two or more vinyl aromatic monomers are also useful.

Although not critical, the alkenyl aromatic polymer may have a high degree of syndiotactic configuration; i.e., the aromatic groups are located alternately at opposite directions relative to the main chain that consists of carbon-carbon bonds. Homopolymers of vinyl aromatic polymers that have syndiotacticity of 75% r diad or greater or even 90% r diad or greater as measured by ¹³C NMR are useful herein.

The alkenyl aromatic polymer may also contain repeating units derived from one or more other monomers that are copolymerizable with the vinyl aromatic monomer. Suitable such monomers include N-phenyl maleimide; acrylamide; ethylenically unsaturated nitriles such as acrylonitrile and methacrylonitrile; ethylenically unsaturated carboxylic acids and anhydrides such as acrylic acid, methacrylic acid, fumaric anhydride and maleic anhydride; esters of ethylenically unsaturated acids such as C₁-C₈ alkyl acrylates and methacrylates, for example n-butyl acrylate and methyl methacrylate; and conjugated dienes such as butadiene or isoprene. The interpolymers of these types may be random, block or graft interpolymers. Blends of interpolymers of this type with homopolymers of a vinyl aromatic monomer can be used. For example, styrene/C₄-C₈ alkyl acrylate interpolymers and styrene-butadiene interpolymers are particularly suitable as impact modifiers when blended into polystyrene. Such impact-modified polystyrenes are useful herein.

In addition, the alkenyl aromatic polymers include those modified with rubbers to improve their impact properties. The modification can be, for example, through blending, grafting or polymerization of a vinyl aromatic monomer (optionally with other monomers) in the presence of a rubber compound. Examples of such rubbers are homopolymers of C₄-C₆ conjugated dienes such as butadiene or isoprene; ethylene/propylene interpolymers; interpolymers of ethylene, propylene and a nonconjugated diene such as 1,6-hexadiene or ethylidene norbornene; C₄-C₆ alkyl acrylate homopolymers or interpolymers, including interpolymers thereof with a C₁-C₄ alkyl acrylate. The rubbers are conveniently prepared by anionic solution polymerization techniques or by free radical initiated solution, mass or suspension polymerization processes. Rubber polymers that are prepared by emulsion polymerization may be agglomerated to produce larger particles having a multimodal particle size distribution.

Preferred impact modified alkenyl aromatic polymers are prepared by dissolving the rubber into the vinyl aromatic monomer and any comonomers and polymerizing the resulting solution, preferably while agitating the solution so as to prepare a dispersed, grafted, impact modified polymer having rubber domains containing occlusions of the matrix polymer dispersed throughout the resulting polymerized mass. In such products, polymerized vinyl aromatic monomer forms a continuous polymeric matrix. Additional quantities of rubber polymer may be blended into the impact modified polymer if desired.

Commercial PS (polystyrene), HIPS (high impact polystyrene), ABS (acrylonitrile-butadiene-styrene) and SAN (styrene-acrylonitrile) resins that are melt processable are particularly useful in this invention.

The alkenyl aromatic polymer has a molecular weight such that it can be melt processed with a blowing agent to form a cellular foam structure. A number average molecular weight of about 60,000 to about 350,000, preferably from about 100,000 to about 300,000, is particularly suitable. In the case of an impact modified polymer, these molecular weight numbers refer to molecular weight of the matrix polymer (i.e., the continuous phase polymer of a vinyl aromatic monomer).

α-Olefin Polymer

The α-olefin polymer is a polymer or interpolymer containing repeated units derived by polymerizing an α-olefin. The α-olefin polymer contains essentially no polymerized vinyl aromatic monomers and no sterically hindered aliphatic or cycloaliphatic vinyl or vinylidene monomers. Particularly suitable α-olefins have from 2 to about 20 carbon atoms, preferably from 2 to about 8 carbon atoms, and include ethylene, propylene, 1-butene, 4-methyl-1-pentene, 1-hexene, 1-octene and the like. Preferred α-olefin polymers are homopolymers of ethylene or propylene and interpolymers of ethylene with a C₃-C₈ α-olefin. The α-olefin polymer may also contain, in polymerized form, one or more other non-aromatic monomers that are interpolymerizable with the α-olefin and which are neither aromatic nor contain a aliphatic or cycloaliphatic group. Such monomers include, for example, vinyl acetate, acrylic acid, methacrylic acid, esters of acrylic or methacrylic acid and acid anhydrides such as maleic anhydride. The α-olefin polymer preferably contains at least 75% by weight, preferably at least 95% by weight, of polymerized α-olefin monomers. More preferably, the α-olefin polymer contains at least 85% by weight polymerized ethylene, with polymerized α-olefin monomers constituting the remainder of the polymer.

Particularly suitable α-olefin polymers include low density polyethylene (LDPE), which term is used herein to designate polyethylene homopolymers made in a high pressure, free radical polymerization process. These LDPE polymers are characterized by having a high degree of long chain branching. LDPE useful in this invention preferably has a density of about 0.910 to 0.940 g/cc (ASTM D792) and a melt index from about 0.02 to about 100 grams per 10 minutes, preferably from 0.1 to about 50 grams per 10 minutes (as determined by ASTM Test Method D 1283, condition 190° C./2.16 kg).

The so-called linear low density polyethylene (LLDPE) and high density polyethylene (HDPE) products are also useful herein. These polymers are homopolymers of polyethylene or copolymers thereof with one or more higher α-olefins and characterized by the near or total absence (less than 0.01/1000 carbon atoms) of long chain branching. LLDPE and HDPE are made in a low pressure process employing conventional Ziegler-Natta type catalysts, as described in U.S. Pat. No. 4,076,698. LLDPE and HDPE are generally distinguished by the level of α-olefin comonomer that is used in their production, with LLDPE containing higher levels of comonomer and accordingly lower density. Suitable LLDPE polymers having a density of from about 0.85 to about 0.940 g/cc (ASTM D 792) and a melt index (ASTM D 1238, condition 190° C./2.16 kg) of about 0.01 to about 100 grams/10 minutes. Suitable HDPE polymers have a similar melt index, but have a density of greater than about 0.940 g/cc.

Another suitable α-olefin polymer includes polypropylene. High melt strength polypropylene resins are preferred. The propylene polymer material may be comprised solely of one or more propylene homopolymers, one or more propylene copolymers, and blends of one or more of each of propylene homopolymers and copolymers; propylene homopolymers are preferred. The propylene polymer preferably has a weight average molecular weight (M_{w}) of at least 100,000. M_{w} can be measured by known procedures. Preferred propylene polymers include those that are branched or lightly cross-linked. Branching (or light cross-linking) may be obtained by those methods generally known in the art, such as chemical or irradiation branching/light cross-linking. One such resin which is prepared as a branched/lightly cross-linked polypropylene resin prior to using the polypropylene resin to prepare a finished polypropylene resin product and the method of preparing such a polypropylene resin is described in U.S. Pat. No. 4,916,198, which is hereby incorporated by reference. Another method to prepare branched/lightly cross-linked polypropylene resin is to introduce chemical compounds into the extruder, along with a polypropylene resin and allow the branching/lightly cross-linking reaction to take place in the extruder. This method is illustrated in U.S. Pat. Nos. 3,250,731 with a polyfunctional azide, U.S. Pat. No. 4,714,716 (and published International Application WO 99/10424) with an azidofunctional silane and EP 879,844-A1 with a peroxide in conjunction with a multi-vinyl functional monomer. The aforementioned U.S. patents are incorporated herein by reference. Irradiation techniques are illustrated by U.S. Pat. Nos. 5,605,936 and 5,883,151, which are also incorporated by reference.

Another suitable type of α-olefin polymer are LLDPE polymers having a homogeneous distribution of the comonomer, as are described, for example, in U.S. Pat. No. 3,645,992 to Elston and U. S. Pat. Nos. 5,026,798 and 5,055,438 to Canich.

Yet another type of α-olefin polymer are substantially linear olefin polymers as described in U.S. Pat. Nos. 5,272,236 and 5,278,272, incorporated herein by reference. The substantially linear olefin polymer is advantageously a homopolymer of a C₂-C₂₀ α-olefin or, preferably, an interpolymer of ethylene with at least one C₃-C₂₀ α-olefin and/or a C₄-C₁₈ diolefin. These polymers contain a small amount of long-chain branching (i.e. about 0.01 to about 3, preferably about 0.01 to about 1 and more preferably about 0.3 to about 1 long chain branch per 1000 carbon atoms) and typically exhibit only a single melting peak by differential scanning calorimetry. Particularly suitable substantially linear olefin polymers have a melt index (ASTM D-1238, Condition 190° C./2.16 kg) of from about 0.01 to about 1000 g/10 min, and a density of from 0.85 to 0.97 g/cc, preferably 0.85 to 0.95 g/cc and especially 0.85 to 0.92 g/cc.

In addition, α-olefin polymers that have been subjected to coupling or light crosslinking treatments are useful herein, provided that they remain melt processable. Such grafting or light crosslinking techniques include silane grafting as described in U.S. Pat. No. 4,714,716 to Park; peroxide coupling as described in U.S. Pat. No. 4,578,431 to Shaw et al., and irradiation as described in U.S. Pat. No. 5,736,618 to Poloso. Preferably, the treated polymer has a gel content of less than 10%, more preferably less than 5%, most preferably less than 2% by weight, as determined by gel permeation chromatography. Treatment of this type is of particular interest for HDPE, LLDPE or substantially linear polyethylene copolymers, as it tends to increase the melt tension and melt viscosity of those polymers to a range that improves their ability to be processed into foam in an extrusion process.

Polymeric Compatibilizer

The polymer blend further contains a polymeric compatibilizer for the alkenyl aromatic polymer and the α-olefin polymer. The polymeric compatibilizer prevents macroscopic phase separation of the polymer blend, and the polymer blend is melt processable to form a foam. Without the compatibilizer, the alkenyl aromatic polymer and the α-olefin polymer are difficult to blend and difficult to foam. The compatibilizer enhances the mixing between the polymeric components. Suitable compatibilizers include certain aliphatic α-olefin/vinyl aromatic interpolymers.

Examples of suitable aliphatic α-olefin/vinyl interpolymers include the substantially random interpolymers prepared by polymerizing i) ethylene and/or one or more α-olefin monomers and ii) one or more vinyl or vinylidene aromatic monomers and/or one or more sterically hindered aliphatic or cycloaliphatic vinyl or vinylidene monomers, and optionally iii) other polymerizable ethylenically unsaturated monomer(s). The interpolymer contains, for example, in polymerized form, from about 35 to about 95 preferably about 50 to about 93, more preferably about 55 to about 90 mole percent of monomer type i), about 5 to about 65, preferably about 7 to about 50, more preferably about 10 to about 45 mole percent of monomer type ii), and up to 30, preferably no more than 20 mole percent of monomer type iii). The interpolymer advantageously has a melt flow index (190° C./2. 16 kg) of about 0.1 to about 100, preferably about 0.2 to about 50, more preferably from about 0.3 to about 25 g/10 min and a molecular weight distribution which is a weight average molecular weight/number average molecular weight (M_{w}/Mₙ) is from about 1.5 to about 20, preferably of from about 1.8 to about 10, more preferably of from about 2 to about 5.

Examples of suitable α-olefins include for example, α-olefins containing from 3 to about 20, preferably from 3 to about 12, more preferably from 3 to about 8 carbon atoms. Particularly suitable are ethylene, propylene, butene-1,4-methyl-1-pentene, hexene-1 or octene-1 or ethylene in combination with one or more of propylene, butene-1,4-methyl-1-pentene, hexene-1 or octene-1. These α-olefins do not contain an aromatic, hindered aliphatic or cycloaliphatic moieties.

Other optional polymerizable ethylenically unsaturated monomer(s) include norbornene and C₁₋₁₀ alkyl or C₆₋₁₀ aryl substituted norbornenes, with an exemplary interpolymer being ethylene/styrene/norbornene.

Vinyl or vinylidene aromatic monomers which can be employed to prepare the interpolymers include, for example, those represented by the following formula:

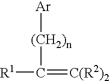

wherein R¹ is selected from the group of radicals consisting of hydrogen and alkyl radicals containing from 1 to about 4 carbon atoms, preferably hydrogen or methyl; each R² is independently selected from the group of radicals consisting of hydrogen and alkyl radicals containing from 1 to about 4 carbon atoms, preferably hydrogen or methyl; Ar is a phenyl group or a phenyl group substituted with from 1 to 5 substituents selected from the group consisting of halo, C₁₋₄-alkyl, and C₁₋₄-haloalkyl; and n has a value from zero to about 4, preferably from zero to 2, most preferably zero. Exemplary vinyl or vinylidene aromatic monomers include styrene, vinyl toluene, α-methylstyrene, t-butyl styrene, chlorostyrene, including all isomers of these compounds, and the like. Particularly suitable such monomers include styrene and lower alkyl- or halogen-substituted derivatives thereof. Preferred monomers include styrene, α-methyl styrene, the lower alkyl-(C₁-C₄) or phenyl-ring substituted derivatives of styrene, such as for example, ortho-, meta-, and para-methylstyrene, the ring halogenated styrenes, para-vinyl toluene or mixtures thereof, and the like. A more preferred aromatic vinyl monomer is styrene.

By the terms “sterically hindered aliphatic or cycloaliphatic vinyl or vinylidene compounds”, it is meant addition polymerizable vinyl or vinylidene monomers corresponding to the formula:

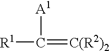

wherein A¹ is a sterically bulky, aliphatic or cycloaliphatic substituent of up to 20 carbons, R¹ is selected from the group of radicals consisting of hydrogen and alkyl radicals containing from 1 to about 4 carbon atoms, preferably hydrogen or methyl; each R² is independently selected from the group of radicals consisting of hydrogen and alkyl radicals containing from 1 to about 4 carbon atoms, preferably hydrogen or methyl; or alternatively R¹ and A¹ together form a ring system. Preferred aliphatic or cycloaliphatic vinyl or vinylidene compounds are monomers in which one or the carbon atoms bearing ethylenic unsaturation is tertiary or quaternary substituted. Examples of such substituents include cyclic aliphatic groups such as cyclohexyl, cyclohexenyl, cyclooctenyl, or ring alkyl or aryl substituted derivatives thereof, tert-butyl, norbornyl, and the like. Most preferred aliphatic or cycloaliphatic vinyl or vinylidene compounds are the various isomeric vinyl-ring substituted derivatives of cyclohexene and substituted cyclohexenes, and 5-ethylidene-2-norbornene. Especially suitable are 1-, 3-, and 4-vinylcyclohexene. Simple linear non-branched α-olefins including for example, α-olefins containing from 3 to about 20 carbon atoms such as propylene, butene-1,4-methyl-1-pentene, hexene-1 or octene-1 are not examples of sterically hindered aliphatic or cycloaliphatic vinyl or vinylidene compounds.

The substantially random interpolymers include the pseudo-random interpolymers as described in EP-A-0,416,815 by James C. Stevens et al., (equivalent to U.S. Pat. No. 5,872,201) and U.S. Pat. No. 5,703,187 by Francis J. Timmers, both of which are incorporated herein by reference in their entirety. The substantially random interpolymers are conveniently made by polymerizing a mixture of polymerizable monomers in the presence of one or more metallocene or constrained geometry catalysts in combination with various cocatalysts. Preferred operating conditions for such polymerization reactions are pressures from atmospheric up to 3000 atmospheres and temperatures from −30° C. to 200° C. Polymerizations and unreacted monomer removal at temperatures above the autopolymerization temperature of the respective monomers may result in formation of some amounts of homopolymer polymerization products resulting from free radical polymerization.

Examples of catalysts and methods for preparing the substantially random interpolymers are disclosed in European Application Nos. EP-A-416,815; EP-A-514,828; allowed U.S. application Ser. No. 09/302,067; as well as U.S. Pat. Nos. 5,055,438; 5,057,475; 5,096,867; 5,064,802; 5,132,380; 5,189,192; 5,321,106; 5,347,024; 5,350,723; 5,374,696; 5,399,635; 5,470,993; 5,703,187; 5,721,185; 5,929,154; 6,013,819; and 6,048,909. All of the foregoing are fully incorporated herein by reference.

The substantially random α-olefin/vinyl aromatic interpolymers can also be prepared by the methods described in JP 07/278230 employing as catalysts compounds shown by the general formula:

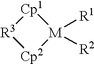

where Cp¹ and Cp² are cyclopentadienyl groups, indenyl groups, fluorenyl groups, or substituents of these, independently of each other; R¹ and R² are hydrogen atoms, halogen atoms, hydrocarbon groups with carbon numbers of 1-12, alkoxyl groups, or aryloxyl groups, independently of each other; M is a group IV metal, preferably Zr or Hf, most preferably Zr; and R³ is an alkylene group or silanediyl group used to cross-link Cp¹ and Cp².

The substantially random α-olefin/vinyl aromatic interpolymers can also be prepared by the methods described by John G. Bradfute et al. (W. R. Grace & Co.) in WO 95/32095; by R. B. Pannell (Exxon Chemical Patents, Inc.) in WO 94/00500; and in Plastics Technology, p. 25 (September 1992), all of which are incorporated herein by reference in their entirety.

Also of interest are the substantially random interpolymers which comprise at least one α-olefin/vinyl aromatic/vinyl aromatic/α-olefin tetrad disclosed in WO 98/09999 by Francis J. Timmers et al. These interpolymers contain additional signals in their carbon-13 NMR spectra with intensities greater than three times the peak to peak noise. These signals appear in the chemical shift range 43.70-44.25 ppm and 38.0-38.5 ppm. Specifically, major peaks are observed at 44.1, 43.9, and 38.2 ppm. A proton test NMR experiment indicates that the signals in the chemical shift region 43.70-44.25 ppm are methine carbons and the signals in the region 38.0-38.5 ppm are methylene carbons.

It is believed that these new signals are due to sequences involving two head-to-tail vinyl aromatic monomer insertions preceded and followed by at least one α-olefin insertion, e.g. an ethylene/styrene/styrene/ethylene tetrad wherein the styrene monomer insertions of said tetrads occur exclusively in a 1,2 (head to tail) manner. It is understood by one skilled in the art that for such tetrads involving a vinyl aromatic monomer other than styrene and an α-olefin other than ethylene that the ethylene/vinyl aromatic monomer/vinyl aromatic monomer/ethylene tetrad will give rise to similar carbon-13 NMR peaks but with slightly different chemical shifts.

Further preparative methods for the interpolymers used in the present invention have been described in the literature. Longo and Grassi (Makromol. Chem., Volume 191, pages 2387 to 2396 [1990]) and D'Anniello et al. (Journal of Applied Polymer Science, Volume 58, pages 1701-1706 [1995]) reported the use of a catalytic system based on methylalumoxane (MAO) and cyclopentadienyltitanium trichloride (CpTiCl₃) to prepare an ethylene-styrene copolymer. Xu and Lin (Polymer Preprints, Am. Chem. Soc., Div. Polym. Chem.) Volume 35, pages 686,687 [1994]) have reported copolymerization using a MgCl₂/TiCl₄/NdCl₃/Al(iBu)₃ catalyst to give random copolymers of styrene and propylene. Lu et al (Journal of Applied Polymer Science, Volume 53, pages 1453 to 1460 [1994]) have described the copolymerization of ethylene and styrene using a TiC1₄/NdCl₃/MgCl₂/Al(Et)₃ catalyst. Semetz and Mulhaupt, (Macromol. Chem. Phys., v. 197, pp. 1071-1083, 1997) have described the influence of polymerization conditions on the copolymerization of styrene with ethylene using Me₂Si(Me₄Cp) (N-tert-butyl)TiCl₂/methylaluminoxane Ziegler-Natta catalysts. Copolymers of ethylene and styrene produced by bridged metallocene catalysts have been described by Arai, Toshiaki and Suzuki (Polymer Preprints, Am. Chem. Soc., Div. Polym. Chem.) Volume 38, pages 349, 350 [1997]) and in U.S. Pat. No. 5,652,315, issued to Mitsui Toatsu Chemicals, Inc. The manufacture of α-olefin/vinyl aromatic monomer interpolymers such as propylene/styrene and butene/styrene are described in U.S. Pat. No. 5,244,996, issued to Mitsui Petrochemical Industries Ltd or U.S. Pat. No. 5,652,315 also issued to Mitsui Petrochemical Industries Ltd or as disclosed in DE 197 11 339 A1 to Denki Kagaku Kogyo KK. All the above methods disclosed for preparing the interpolymer component are incorporated herein by reference. Also, the random copolymers of ethylene and styrene as disclosed in Polymer Preprints Vol 39, No. 1, March 1998 by Toru Aria et al. can also be employed as compatibilizers in the present invention.

While preparing the substantially random interpolymer, an amount of atactic vinyl aromatic homopolymer may be formed due to homopolymerization of the vinyl aromatic monomer at elevated temperatures. The presence of vinyl aromatic homopolymer is in general not detrimental for the purposes of the present invention and can be tolerated. The vinyl aromatic homopolymer may be separated from the interpolymer, if desired, by extraction techniques such as selective precipitation from solution with a non solvent for either the interpolymer or the vinyl aromatic homopolymer. For the purpose of the present invention it is preferred that no more than 30 weight percent, preferably less than 20 weight percent based on the total weight of the interpolymers of atactic vinyl aromatic homopolymer is present.

Blends of an alkenyl aromatic polymer with an α-olefin polymer using an α-olefin/vinyl aromatic interpolymer as a compatibilizer are described in U.S. Pat. No. 5,460,818 incorporated herein by reference.

Preferred interpolymers are substantially random ethylene-styrene and ethylene/propylene/styrene interpolymers. Such polymers preferably have a styrene content from about 5 to about 65 mole percent, preferably from about 7 to about 50, more preferably from about 10 to about 45 mole percent measured as described, for example, in U.S. Pat. No. 6,048,909 to Chaudhary. Most preferred are interpolymers such as those marketed by The Dow Chemical Company under the INDEX™ tradename.

The polymer blend contains, from about 25 to about 75, preferably from about 30 to about 70, more preferably from about 35 to about 65% by weight alkenyl aromatic polymer, from about 25 to about 75, preferably from about 30 to about 70, more preferably from about 35 to about 65% by weight α-olefin polymer, and from about 5 to about 50, preferably from about 7 to about 45, more preferably from about 10 to about 40% by weight substantially random interpolymer compatibilizer, all said percentages being based on the combined weight of the alkenyl aromatic polymer, α-olefin polymer and substantially random interpolymer compatibilizer.

The density of the foam is from about 5 to about 110, preferably from about 10 to about 80, more preferably from about 10 to about 60 kg per cubic meter.

The Asker C hardness of the foam is less than about 65, preferably less than about 60, more preferably less than about 50.

A high concentration of alkenyl aromatic polymer tends to improve dimensional stability but decrease softness. A high concentration of α-olefin polymer tends to improve softness but may reduce dimensional stability. The substantially random interpolymer compatibilizer tends to improve compatibility and softness, but a high concentration may decrease dimensional stability and increase creep.

The polymer blend can be prepared by simple melt blending. If desired, the individual polymers can be separately charged into an extruder together with blowing agent and other auxiliaries to form the polymer blend as part of the foam-making process. Alternatively, the polymer blend can be made separately prior to the foaming process. The dispersion of the polymer components should be uniform.

The polymer blend or any component thereof can contain additives that do not undesirably interfere with the foaming process or the cushioning properties of the resulting foam. Antioxidants, colorants, fillers, dyes, slip agents, flame-retardants and the like are common such additives.

The polymer blend compositions described above may be converted to foam products using any conventional process. Foam products include, for example, extruded thermoplastic polymer foam, extruded polymer strand foam, expandable thermoplastic foam beads, expanded thermoplastic foam beads or expanded and fused thermoplastic foam beads. The foam products may be converted into fabricated articles using any conventional process or method. For example, any one or more of expansion, coalescing and welding may be used in making such articles, especially from expandable foam beads. The foam products may take any known physical configuration, such as extruded sheet, round, rod, plank, and profiles. Expandable beads may also be molded into any known configuration that employs foam products, including, but not limited to the foregoing configurations.

Conventional LDPE foam processes have a significant limitation in the temperature ranges over which suitable foams may be made. That range is frequently no more than 1° C. Polymer blend foams of the present invention have a broader temperature range (for example, as high as 4° C.). This allows for greater control in selecting foam properties such as open cell content.

Polymer foams of the present invention readily result from conventional foam preparation techniques. Using a conventional extrusion foaming process by way of example, polymer blend components are converted into a polymer melt and a blowing agent is incorporated into the polymer melt to form a foamable gel. The foamable gel is then extruded through a die to form a desired product. Depending upon the die and operating conditions, the product may vary from an extruded foam plank or rod through a coalesced foam strand product, to foam beads and eventually to chopped strands of foamable beads.

Prior to extruding foamable gel through the die, typically the gel is cooled to an optimum temperature. To make a foam, the optimum temperature is one at which stable foam exists and desirably falls within 30° centigrade (° C.) of the highest crystalline melting point (Tₘ) or glass transition temperature (T_{g}) of the components of the polymer blend before exiting the die. For foams of the present invention, an optimum foaming temperature is in a range in which the foam does not collapse.

The crystalline melting point or glass transition temperature are measured using a differential scanning calorimeter (DSC). The following procedure is used: a 5 gram sample is heated rapidly in a sealed aluminum pan from ambient temperature to 180° C. (at a rate of 105° C. per minute); kept at 180° C. for 4 minutes to ensure complete melting; cooled at 10° C./min to about 40° C. below the expected T_{g}; kept at this temperature for four minutes for DSC stabilization; and heated to 150° C. at 10° C./min. The Tm is obtained from the melting curve and is the peak melting temperature. T_{g} is obtained using the half-height method from the DSC melting curve (also called second heat).

The blowing agent may be incorporated or mixed into the polymer melt by any means known in the art such as with an extruder, mixer, or blender. The blowing agent is mixed with the polymer melt at an elevated pressure sufficient to prevent substantial expansion of the melt polymer material and to generally disperse the blowing agent homogeneously therein. Optionally, a nucleator may be blended in the polymer melt or dry blended with the polymer material prior to plasticizing or melting.

The blend components may be dry-blended and fed to an extruder hopper. Either component may also be added to an extruder after the other components are at least partially in a melt state. When so added, said components may be part of a polymer concentrate that may include other additives or ingredients such as a pigment.

When making extruded foam, extruded strand foam or foam beads, the cooled, foamable gel passes through a die of desired shape (with an appropriate number of apertures) and enters a zone of reduced or lower pressure that promotes foaming. The zone of lower pressure is at a pressure lower than that in which the foamable gel is maintained prior to extrusion through the die. The lower pressure may be superatmospheric or subatmospheric (vacuum), but is preferably at an atmospheric level.

The present foam structures may be formed in a coalesced strand form by extrusion of the compositions of the present invention through a multi-orifice die. The orifices are arranged so that contact between adjacent streams of the molten extrudate occurs during the foaming process and the contacting surfaces adhere to one another with sufficient adhesion to result in a unitary foam structure. The streams of molten extrudate exiting the die take the form of strands or profiles, which desirably foam, coalesce, and adhere to one another to form a unitary structure. Desirably, the coalesced individual strands or profiles should remain adhered in a unitary structure to prevent strand delamination under stresses encountered in preparing, shaping, and using the foam. U.S. Pat. No. 3,573,152 and U.S. Pat. No. 4,824,720, the teachings of which are incorporated herein by reference, disclose apparatus and methods used in making coalesced foam structures.

Foams of the present invention may also be made using an accumulating extrusion process and apparatus such as that shown in U.S. Pat. No. 4,323,528 and U.S. Pat. No. 5,817,705, the teachings of which are incorporated herein by reference. This apparatus, commonly known as an “extruder-accumulator system” allows process operation on an intermittent, rather than a continuous, basis. The apparatus includes a holding zone or accumulator where foamable gel remains under conditions that preclude foaming. The holding zone is equipped with an outlet die that opens into a zone of lower pressure, such as the atmosphere. The die has an orifice that may be open or closed, preferably by way of a gate that is external to the holding zone. Operation of the gate does not affect the foamable composition other than to allow it to flow through the die. Opening the gate and substantially concurrently applying mechanical pressure on the gel by a mechanism (e.g. a mechanical ram) forces the gel through the die into a zone of lower pressure. The mechanical pressure is sufficient to force foamable gel through the die at a rate fast enough to preclude significant foaming within the die yet slow enough to minimize and preferably eliminate generation of irregularities in foam cross-sectional area or shape. As such, other than operating intermittently, the process and its resulting products closely resemble those made in a continuous extrusion process.

The present foam structures may also be formed into foam beads suitable for molding into articles by expansion of pre-expanded beads containing a blowing agent. The beads may be molded at the time of expansion to form articles of various shapes. Processes for making expanded beads and molded expanded beam foam articles are described in Plastic Foams, Part II, Frisch And Saunders, pp. 544-585, Marcel Dekker, Inc. (1973) and Plastic Materials, Brydson, 5th Ed., pp. 426-429, Butterworths (1989).

Expandable and expanded beads can be made by a batch or by an extrusion process. The batch process of making expandable beads is similar to manufacturing expandable polystyrene (EPS). Impregnate polymer blend granules, made either by melt blending or in-reactor blending, with a blowing agent in an aqueous suspension or in an anhydrous state in a pressure vessel at an elevated temperature and pressure. Either discharge the granules rapidly into a region of reduced pressure to expand the granules into foam beads or cool and discharge the granules as unexpanded beads. In a separate step, heat the unexpanded beads to expand them, e.g., with steam or with hot air.

The extrusion method tracks with the conventional foam extrusion process described above up to the die orifice. The die has multiple holes. In order to make unfoamed beads, immediately quench the foamable strands exiting the die orifice in a cold water bath to prevent foaming and then pelletize the quenched strands. Alternately, convert the strands to foam beads by cutting the strands into pellets or granules at the die face and allowing the granules to expand.

The foam beads may then be molded by any means known in the art, such as charging the foam beads to the mold, compressing the mold to compress the beads, and heating the beads such as with steam to effect coalescing and welding of the beads to form the article. Optionally, the beads may be impregnated with air or other blowing agent at an elevated pressure and temperature prior to charging to the mold. Further, the beads may be heated prior to charging. The foam beads may then be molded to blocks or shaped articles by a suitable molding method known in the art. Some of the methods are taught in U.S. Pat. No. 3,504,068 and U.S. Pat. No. 3,953,558, both incorporated herein by reference. C. P. Park, supra, p. 191, pp. 197-198, and pp. 227-229, provides excellent teachings, incorporated herein by reference, of the above processes and molding methods.

U.S. Pat. No. 4,379,859 and U.S. Pat. No. 4,464,484, the teachings of which are incorporated herein by reference, disclose preparation of foam beads. When making foam beads rather than foam, first convert blends used to prepare foams of the present invention into discrete resin particles such as granulated resin pellets. Suspend the particles in a liquid medium, such as water, in which they are substantially insoluble and then introduce a blowing agent into the liquid medium. Use of an elevated temperature and pressure in a pressure vessel such as an autoclave facilitates impregnating the particles with the blowing agent. Rapidly discharge the impregnated particles from the pressure vessel into an atmosphere or a region of reduced pressure to expand the particles into foam beads.

A variation of the foregoing extrusion process readily yields expandable thermoplastic polymer beads. The variation requires (a) cooling the foamable gel to a temperature below that at which foaming occurs, (b) extruding cooled gel through a die containing one or more orifices to form a corresponding number of essentially continuous expandable thermoplastic strands, and (c) pelletizing the expandable thermoplastic strands to form expandable thermoplastic beads.

Expanding agents include both physical and chemical blowing agents. Physical blowing agents include gasses and liquids that volatilize under the conditions of the foaming process, whereas chemical blowing agents produce a gas under the condition of the foaming process through some chemical means, usually decomposition. Particularly suitable physical blowing agents include halocarbons containing 1 or 2 carbon atoms such as methyl chloride, ethyl chloride, dichloromonofluoromethane, trichlorofluoromethane, monofluoromonochloromethane, 1,1,2-trifluorotrichloroethane, 1,1,2,2-tetrafluorodichlorethane, 1,2,2,2-tetrafluoroethane, and 1,2,2-trifluoroethane. Also suitable are saturated or unsaturated hydrocarbons containing from 3 to 8 carbon atoms such as propane, n-butane, isobutane, pentane, hexane, octane, propene, 1-butene, 1-pentene, isopentane and 2,2-dimethylbutane. Carbon dioxide, nitrogen, argon, water and the like are also useful. Mixtures of these physical expanding agents can be used. Chemical blowing agents include, for example, azodicarbonamide, dinitrosopentamethylene tetramine, benzenesulfonyl hydrazide and toluene sulfonyl hydrizide. Isobutane is a highly preferred blowing agent.

The amount of blowing agent incorporated into the polymer melt material to make the foams of the present invention is from about 0.4 to about 5.0 gram-moles per kilogram of polymer, preferably from about 0.6 to about 3.0 gram-moles per kilogram of polymer, and most preferably from about 0.8 to 2.5 gram-moles per kilogram of polymer.

A nucleating agent (or cell control agent) can be used to help control the size of the cells. Cell control agents include finely particulate solids such as talc as well as mixtures of sodium bicarbonate with citric acid or sodium citrate. The foam advantageously has a cell size in the range of from about 0.1 mm to about 10 mm, preferably from about 0.2 mm to about 5 mm, more preferably from about 0.3 mm to about 2.5 mm as measured by ASTM D 3756.

The foams of this invention have open cell content ranging from 0 to 100 volume percent (measured in accordance with ASTM D 2856 Procedure A).

The foam has a drop-test optimum C-factor (ASTM-D1596) of <6, desirably <5, and preferably <4. Calculate optimum C-factor at the static load corresponding to the lowest G-values using the formula: C=(G-value×Thickness of Foam)/(Drop Height) where the G-value is determined according to ASTM D 1596 by dropping a load on foam after aging the foam for 28 days at room temperature.

In addition, a stability control agent or permeability modifier such as glycerol monostearate, stearyl stearamide or the like can be used to modify the rate at which the blowing agent escapes from the cells of the foam after the foam is cooled. The use of such stability control agents is described, for example, in U.S. Pat. No. 3,644,230 to Cronin and U.S. Pat. No. 4,395,510 to Park.

Foams of the present invention exhibit excellent dimensional stability even without the addition of a stability control agent. Dimensional stability means that the external dimensions of the foam do not change significantly over time. Preferably, the maximum volume change is not more than about 15 volume percent, more preferably not more than about 10 volume percent, and most preferably not more than about 5 volume percent. Volume measurement may use any suitable method such as cubic displacement of water, or standard geometry calculations. Maximum volume change is measured at 23° C. over time, and refers to the difference between the greatest or lowest volume over the measurement period and the starting volume when the foam is not stressed by a load. The starting volume is measured on fresh foam, when it has cooled to about 23° C.

Dimensional stability is particularly advantageous for foams having relatively large lateral cross-sectional areas. Lateral cross-section may be measured perpendicular to the longest of the three dimensions of the foam. For example, for an extruded sheet, the cross-section would be taken perpendicular to the length of the sheet. For thicker foams, a small percentage change in the volume is more significant than for thinner foams, and thicker foams tend to take much longer to return to their original thickness than thinner foams. Foams having lateral cross-sectional areas greater than about 25 mm², preferably greater than about 100 mm² most readily benefit from the dimensional stability of the foam.

The foams of the present invention may be used in any application where soft, flexible foams are used. Such applications include, without limit, cushion packaging (e.g. corner blocks, braces, saddles, pouches, bags, envelopes, overwraps, interleafing, encapsulation) of finished electronic goods such as computers, televisions, and kitchen appliances; packaging or protection of explosive materials or devices; material handling (trays, tote boxes, box liners, tote box inserts and dividers, shunt, stuffing, boards, parts spacers and parts separators); work station accessories (aprons, table and bench top covers, floor mats, seat cushions); automotive (headliners, impact absorption in bumpers or doors, carpet underlayment, sound insulation); flotation (e.g. life jackets, vests and belts); sports and leisure (e.g. gym mats and bodyboards); thermal insulation such as that used in building and construction); gaskets, grommets, seals; sound attenuation for printers and typewriters; display case insert; missile container padding; military shell holder; blocking and bracing of various items in transport; preservation and packaging; automotives anti-rattle pads, seals; medical devices, skin contact pads; cushioned pallet; and vibration isolation pad. The foregoing list merely illustrates a number of suitable applications. Skilled artisans can readily envision additional applications without departing from the scope or spirit of the present invention.

It is often desirable to accelerate the aging of the foam in order to remove the blowing agent from the cells before shipping or using the foam. This is particularly true with hydrocarbon or other flammable blowing agents. Accelerated aging can be accomplished by perforation techniques as described in U.S. Pat. No. 5,242,016 to Kolosowski, WO 92/19439 and WO 97/22455 the entire contents of which are herein incorporated by reference, and through heat aging (including but not limited to the conditions described in U.S. Pat. No. 5,059,376 to Pontiff the entire contents of which are herein incorporated by reference), or a combination of both techniques.

In the case of perforation, the foams may (if required for fast cure purposes and to attain accelerated blowing agent release) be modified by introducing a multiplicity of channels or perforations into the foam extending from a surface into the foam, the channels being free of direction with respect to the longitudinal extension of the foam.

The foam is conveniently extruded in the form of sheet or plank material having a thickness of from about 1 to about 200, preferably from about 1.5 to about 100, more preferably about 2 to about 50 mm. Thinner extrusions can be used or laminated in multiple layers if desired. Thicker extrusions can be cut down to lesser thickness. The width of the sheet is not critical, and widths of up to 3 meters or more can be made.

The following examples are provided to illustrate the invention but are not intended to limit to scope thereof. All parts and percentages are by weight unless otherwise indicated.

### EXAMPLES 1-11 AND COMPARATIVE EXAMPLES A, & B

I. Preparation and Testing of Ethylene-Styrene Interpolymers (ESI) ESI's 1-2

A) Melt Flow Measurements

The molecular weight of the ESI samples is conveniently indicated using a melt index measurement according to ASTM D-1238, condition 190° C./2.16 kg. Melt index is inversely proportional to the molecular weight of the polymer. Thus, the higher the molecular weight, the lower the melt index, although the relationship is not linear.

Also useful for indicating the molecular weight of the substantially random interpolymers used in the present invention is the Gottfert melt index (G, cm³/10 min) which is obtained in a similar fashion as for melt index (I₂) using the ASTM D 1238 procedure for automated plastometers, with the melt density set to 0.7632, the melt density of polyethylene at 190° C.

The relationship of melt density to styrene content for ethylene-styrene interpolymers was measured, as a function of total styrene content, at 190° C. for a range of 29.8% to 81.8% by weight styrene. Atactic polystyrene levels in these samples was typically 10% or less. The influence of the atactic polystyrene was assumed to be minimal because of the low levels. Also, the melt density of atactic polystyrene and the melt densities of the samples with high total styrene are very similar. The method used to determine the melt density employed a Gottfert melt index machine with a melt density parameter set to 0.7632, and the collection of melt strands as a function of time while the I₂ weight was in force. The weight and time for each melt strand was recorded and normalized to yield the mass in grams per 10 minutes. The instrument's calculated I₂ melt index value was also recorded. The equation used to calculate the actual melt density is

δ=δ_{0.7632}×I₂/I₂ Gottfert

where δ_{0.7632}=0.7632 and I₂ Gottfert=displayed melt index.

A linear least squares fit of calculated melt density versus total styrene content leads to an equation with a correlation coefficient of 0.91 for the following equation:

δ_{0.00299}×S+0.723

where S=weight percentage of styrene in the polymer. The relationship of total styrene to melt density can be used to determine an actual melt index value, using these equations if the styrene content is known.

So for a polymer that is 73% total styrene content with a measured melt flow (the “Gotffert number”), the calculation becomes:

δ=0.00299*73+0.723=0.9412

where 0.9412/0.7632=I₂/G# (measured)=1.23

B) Analysis of Randomly Polymerized Styrene Content and Polystyrene Homopolymer Content in ESI Interpolymers

Interpolymer styrene content and the concentration of atactic polystyrene homopolymer impurity in the ESI interpolymers are determined using proton nuclear magnetic resonance (¹H NMR). All proton NMR samples are prepared in 1,1,2,2-tetrachloroethane-d₂ (tce-d₂). The resulting solutions contain 2.4 weight percent polymer for ESI-2. The interpolymers are weighed directly into 5-mm sample tubes. A 0.75-ml aliquot of tce-d₂ is added by syringe and the tube is capped with a tight-fitting cap. The samples are heated at 85° C. to soften the interpolymer. To provide mixing, the capped samples are occasionally brought to reflux using a heat gun.

Proton NMR spectra are accumulated with the sample probe at 80° C., and referenced to the residual protons of tce-d₂ at 5.99 ppm. Data is collected in triplicate on each sample. The following instrumental conditions are used for analysis of the interpolymer samples:

Sweep width, 5000 hz

Acquisition time, 3.002 sec

Pulse width, 8 μsec

Frequency, 300 mhz

Delay, 1 sec

Transients, 16

The total analysis time per sample is about 10 minutes.

Initially, a spectrum for a sample of a 192,000 M_{w} polystyrene is acquired. Polystyrene has five different types of protons that are distinguishable by proton NMR. These protons are labeled b, branch; α, alpha; o, ortho; m, meta; p, para, as shown below. For each repeating unit in the polymer, there are one branch proton, two-alpha protons, two ortho protons, two meta protons and one para proton.

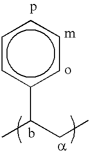

The NMR spectrum for polystyrene homopolymer includes a resonance centered around a chemical shift of about 7.1 ppm, which is believed to correspond to the three ortho and para protons. It includes another peak centered around a chemical shift of about 6.6 ppm. That peak corresponds to the two meta protons. Other peaks at about 1.5 and 1.9 ppm correspond to the three aliphatic protons (alpha and branch).

The relative intensities of the resonances for each of these protons are determined by integration. The integral corresponding to the resonance at 7.1 ppm is designated PS_{7.1} below. That corresponding to the resonance at 6.6 ppm is designated PS_{6.6}, and that corresponding to the aliphatic protons (integrated from 0.8-2.5 ppm) is designated PSₐₗ. The theoretical ratio for PS_{7.1}: PS_{6.6}: PSₐₗ is 3:2:3, or 1.5:1:1.5. For atactic polystyrene homopolymer, all spectra collected have the expected 1.5:1:1.5 integration ratio. An aliphatic ratio of 2 to 1 is predicted based on the protons labeled α and b respectively in FIG. 1. This ratio is also observed when the two aliphatic peaks are integrated separately. Further, the ratio of aromatic to aliphatic protons is measured to be 5 to 3, as predicted from theoretical considerations.

Then, the ¹H NMR spectrum for the ESI interpolymer is acquired. This spectrum shows resonances centered at about 7.1 ppm, 6.6 ppm and in the aliphatic region. However, the 6.6 ppm peak is relatively much weaker for the ESI interpolymer than for the polystyrene homopolymer. The relative weakness of this peak is believed to occur because the meta protons in the ESI copolymer resonate in the 7.1 ppm region. Thus, the only protons that produce the 6.6 ppm peak are meta protons associated with atactic polystyrene homopolymer that is an impurity in the ESI. The peak centered at about 7.1 ppm thus includes ortho, meta and para protons from the aromatic rings in the ESI interpolymer, as well as the ortho and para protons from the aromatic rings in the polystyrene homopolymer impurity. The peaks in the aliphatic region include resonances of aliphatic protons from both the ESI interpolymer and the polystyrene homopolymer impurity.

Again, the relative intensities of the peaks are determined by integration. The peak centered around 7.1 ppm is referred to below as I_{7.1}, that centered around 6.6 ppm is I_{6.6} and that in the aliphatic regions is Iₐₗ.

I_{7.1} includes a component attributable to the aromatic protons of the aromatic protons of the ESI interpolymer and a component attributable to the ortho and para protons of the aromatic rings of the polystyrene homopolymer impurity. Thus,

I_{7.1}=I_{c7.1}+I_{ps7.1}

where I_{c7.1} is the intensity of the 7.1 ppm resonance attributable to the aromatic protons in the interpolymer and I_{ps7.1} is the intensity of the 7.1 ppm resonance attributable to the ortho and meta protons of the polystyrene homopolymer.

From theoretical considerations, as confirmed by the ¹H NMR spectrum of the polystyrene homopolymer, the intensity of the 7.1 ppm resonance attributable to the polystyrene homopolymer impurity (I_{ps7.1}), equals 1.5 times the intensity of the 6.6 ppm resonance. This provides a basis for determining I_{c7.1} from measured values, as follows:

I_{c7.1}=I_{7.1}−1.5(I_{6.6}).

Similarly, Iₐₗ can be resolved into resonances attributable to the ESI and the polystyrene homopolymer impurity using the relationship

Iₐₗ=I_{cal}+Iₚₛₐₗ

wherein I_{cal} is the intensity attributable to the aliphatic protons on the interpolymer and Iₚₛₐₗ is the intensity attributable to the aliphatic protons of the polystyrene homopolymer impurity. Again, it is known from theoretical considerations and the spectrum from the atactic polystyrene homopolymer that Iₚₛₐₗ will equal 1.5 times I_{6.6}. Thus the following relationship provides a basis for determining I_{cal} from measured values:

I_{cal}=Iₐₗ−1.5(I_{6.6}).

The mole percent ethylene and styrene in the interpolymer are then calculated as follows:

s_{c}=I_{c7.1}/5

e_{c}=(I_{cal}−(3×s_{c}))/4

E=e_{c}/(s_{c}+e_{c}), and

S=s_{c}/(s_{c}+e_{c}),

wherein E and S are the mole fractions of copolymerized ethylene and styrene, respectively, contained in the interpolymer.

Weight percent ethylene and styrene are calculated using the equations

$$\begin{matrix}Wt \% E = \frac{100 \% * 28 E}{( 28 E + 104 S )} and \\ Wt \% S = \frac{100 \% * 104 S}{( 28 E + 104 S )} .\end{matrix}$$

The weight percent of polystyrene homopolymer impurity in the ESI sample is then determined by the following equation:

$$Wt \% PS = \frac{100 \% * Wt \% S * ( {I}_{6.6} / 2 S ) .}{100 - [ Wt \% S * ( {I}_{6.6} / 2 S ) ]}$$

The total styrene content is also determined by quantitative Fourier transform infrared spectroscopy (FTIR).

C) Preparation of ESI Polymerization Catalysts A and B

Preparation of Catalyst A (dimethyl[N-(1,1-dimethylethyl)-1,1-dimethyl-1-[(1,2,3,4,5-η)-1,5,6,7-tetrahydro-3-phenyl-s-indacen-1-yl]silanaminato(2-)-N]-titanium)

1) Preparation of 3,5,6,7-Tetrahydro-s-Hydrindacen-1(2H)-one

Indan (94.00 g, 0.7954 moles) and 3-chloropropionyl chloride (100.99 g, 0.7954 moles) were stirred in CH₂Cl₂ (300 mL) at 0° C. as AlCl₃ (130.00 g, 0.9750 moles) was added slowly under a nitrogen flow. The mixture was then allowed to stir at room temperature for 2 hours. The volatiles were then removed. The mixture was then cooled to 0° C. and concentrated H₂SO₄ (500 mL) slowly added. The forming solid had to be frequently broken up with a spatula as stirring was lost early in this step. The mixture was then left under nitrogen overnight at room temperature. The mixture was then heated until the temperature readings reached 90° C. These conditions were maintained for a 2 hour period of time during which a spatula was periodically used to stir the mixture. After the reaction period crushed ice was placed in the mixture and moved around. The mixture was then transferred to a beaker and washed intermittently with H₂O and diethylether and then the fractions filtered and combined. The mixture was washed with H₂O (2×200 mL). The organic layer was then separated and the volatiles removed. The desired product was then isolated via recrystallization from hexane at 0° C. as pale yellow crystals (22.36 g, 16.3% yield).

¹H NMR (CDCl₃): d2.04-2.19 (m, 2H), 2.65 (t, ³J_{HH}=5.7 Hz, 2H), 2.84-3.0 (m, 4 H), 3.03 (t, ³J_{HH}=5.5 Hz, 2H), 7.26 (s, 1H), 7.53 (s, 1H).

¹³C NMR (CDCl₃: d25.71, 26.01, 32.19, 33.24, 36.93, 118.90, 122.16, 135.88, 144.06, 152.89, 154.36, 206.50.

GC-MS: Calculated for C₁₂H₁₂O 172.09, found 172.05.

2) Preparation of 1,2,3,5-Tetrahydro-7-phenyl-s-indacen.

3,5,6,7-Tetrahydro-s-Hydrindacen-1(2H)-one (12.00 g, 0.06967 moles) was stirred in diethylether (200 mL) at 0° C. as PhMgBr (0.105 moles, 35.00 mL of 3.0 M solution in diethylether) was added slowly. This mixture was then allowed to stir overnight at room temperature. After the reaction period the mixture was quenched by pouring over ice. The mixture was then acidified (pH=1) with HCl and stirred vigorously for 2 hours. The organic layer was then separated and washed with H₂O (2×100 mL) and then dried over MgSO₄. Filtration followed by the removal of the volatiles resulted in the isolation of the desired product as a dark oil (14.68 g, 90.3% yield).

¹H NMR (CDCl₃): d2.0-2.2 (m, 2H), 2.8-3.1 (m, 4H), 6.54 (s, 1H), 7.2-7.6 (m, 7H).

GC-MS: Calculated for C₁₈H₁₆ 232.13, found 232.05.

3) Preparation of 1,2,3,5-Tetrahydro-7-phenyl-s-indacene, dilithium salt.

1,2,3,5-Tetrahydro-7-phenyl-s-indacen (14.68 g, 0.06291 moles) was stirred in hexane (150 mL) as nBuLi (0.080 moles, 40.00 mL of 2.0 M solution in cyclohexane) was slowly added. This mixture was then allowed to stir overnight. After the reaction period the solid was collected via suction filtration as a yellow solid which was washed with hexane, dried under vacuum, and used without further purification or analysis (12.2075 g, 81.1% yield).

4) Preparation of Chlorodimethyl(1,5,6,7-tetrahydro-3-phenyl-s-indacen-1-yl)silane.

1,2,3,5-Tetrahydro-7-phenyl-s-indacene, dilithium salt (12.2075 g, 0.05102 moles) in THF (50 mL) was added dropwise to a solution of Me₂SiCl₂ (19.5010 g, 0.1511 moles) in THF (100 mL) at 0° C. This mixture was then allowed to stir at room temperature overnight. After the reaction period the volatiles were removed and the residue extracted and filtered using hexane. The removal of the hexane resulted in the isolation of the desired product as a yellow oil (15.1492 g, 91.1% yield).

¹H NMR (CDCl₃): d0.33 (s, 3H), 0.38 (s, 3H), 2.20 (p, ³J_{HH}=7.5 Hz, 2H), 2.9-3.1 (m, 4H), 3.84 (s, 1H), 6.69 (d, ³J_{HH}=2.8 Hz, 1H), 7.3-7.6 (m, 7H), 7.68 (d, ³J_{HH}=7.4 Hz, 2H).

¹³C NMR (CDCl₃): d0.24, 0.38, 26.28, 33.05, 33.18, 46.13, 116.42, 119.71, 127.51, 128.33, 128.64, 129.56, 136.51, 141.31, 141.86, 142.17, 142.41, 144.62.

GC-MS: Calculated for C₂₀H₂₁ClSi 324.11, found 324.05.

5) Preparation of N-(1,1-Dimethylethyl)-1,1-dimethyl-1-(1,5,6,7-tetrahydro-3-phenyl-s-indacen-1-yl)silanamine.

Chlorodimethyl(1,5,6,7-tetrahydro-3-phenyl-s-indacen-1-yl)silane (10.8277 g, 0.03322 moles) was stirred in hexane (150 mL) as NEt₃ (3.5123 g, 0.03471 moles) and t-butylamine (2.6074 g, 0.03565 moles) were added. This mixture was allowed to stir for 24 hours. After the reaction period the mixture was filtered and the volatiles removed resulting in the isolation of the desired product as a thick red-yellow oil (10.6551 g, 88.7% yield).

¹H NMR (CDCl₃): d0.02 (s, 3H), 0.04 (s, 3H), 1.27 (s, 9H), 2.16 (p, ³J_{HH}=7.2 Hz, 2H), 2.9-3.0 (m, 4H), 3.68 (s, 1H), 6.69 (s, 1H), 7.3-7.5 (m, 4H), 7.63 (d, ³J_{HH}=7.4 Hz, 2H).

¹³C NMR (CDCl₃): d-0.32, −0.09, 26.28, 33.39, 34.11, 46.46, 47.54, 49.81, 115.80, 119.30, 126.92, 127.89, 128.46, 132.99, 137.30, 140.20, 140.81, 141.64, 142.08, 144.83.

6) Preparation of N-(1,1-Dimethylethyl)-1,1-dimethyl-1-(1,5,6,7-tetrahydro-3-phenyl-s-indacen-1-yl) silanamine, Dilithium Salt.

N-(1,1-Dimethylethyl)-1,1-dimethyl-1-(1,5,6,7-tetrahydro-3-phenyl-s-indacen-1-yl)silanamine (10.6551 g, 0.02947 moles) was stirred in hexane (100 mL) as nBuLi (0.070 moles, 35.00 mL of 2.0 M solution in cyclohexane) was added slowly. This mixture was then allowed to stir overnight during which time no salts crashed out of the dark red solution. After the reaction period the volatiles were removed and the residue quickly washed with hexane (2×50 mL). The dark red residue was then pumped dry and used without further purification or analysis (9.6517 g, 87.7% yield).

7) Preparation of Dichloro[N-(1,1-dimethylethyl)-1,1-dimethyl-1-[(1,2,3,4,5-η)- 1,5,6,7-tetrahydro-3-phenyl-s-indacen-1-yl]silanaminato(2-) -N]titanium

N-(1,1-Dimethylethyl)-1,1-dimethyl-1-(1,5,6,7-tetrahydro-3-phenyl-s-indacen-1-yl) silanamine, dilithium salt (4.5355 g, 0.01214 moles) in THF (50 mL) was added dropwise to a slurry of TiCl₃(THF)₃ (4.5005 g, 0.01214 moles) in THF (100 mL). This mixture was allowed to stir for 2 hours. PbCl₂ (1.7136 g, 0.006162 moles) was then added and the mixture allowed to stir for an additional hour. After the reaction period the volatiles were removed and the residue extracted and filtered using toluene. Removal of the toluene resulted in the isolation of a dark residue. This residue was then slurried in hexane and cooled to 0° C. The desired product was then isolated via filtration as a red-brown crystalline solid (2.5280 g, 43.5% yield).

¹H NMR (CDCl₃): d0.71 (s, 3H), 0.97 (s, 3H), 1.37 (s, 9H), 2.0-2.2 (m, 2H), 2.9-3.2 (m, 4H), 6.62 (s, 1H), 7.35-7.45 (m, 1H), 7.50 (t, ³J_{HH}=7.8 Hz, 2H), 7.57 (s, 1H), 7.70 (d, ³J_{HH}=7.1 Hz, 2H), 7.78 (s, 1H).

¹H NMR (C₆D₆): d0.44 (s, 3H), 0.68 (s, 3H), 1.35 (s, 9H), 1.6-1.9 (m, 2H), 2.5-3.9 (m, 4H), 6.65 (s, 1H), 7.1-7.2 (m, 1H), 7.24 (t, ³J_{HH}=7.1 Hz, 2H), 7.61 (s, 1 H), 7.69 (s, 1H), 7.77-7.8 (m, 2H).

¹³C NMR (CDCl₃): d1.29, 3.89, 26.47, 32.62, 32.84, 32.92, 63.16, 98.25, 118.70, 121.75, 125.62, 128.46, 128.55, 128.79, 129.01, 134.11, 134.53, 136.04, 146.15, 148.93.

¹³C NMR (C₆D₆): d0.90, 3.57, 26.46, 32.56, 32.78, 62.88, 98.14, 119.19, 121.97, 125.84, 127.15, 128.83, 129.03, 129.55, 134.57, 135.04, 136.41, 136.51, 147.24, 148.96.

8) Preparation of Dimethyl[N-(1,1-dimethylethyl)-1,1-dimethyl-1-[(1,2,3,4,5-η)-1,5,6,7-tetrahydro-3-phenyl-s-indacen-1-yl]silanaminato(2-)-N]titanium

Dichloro[N-(1,1-dimethylethyl)-1,1-dimethyl-1-[(1,2,3,4,5-□)-1,5,6,7-tetrahydro-3-phenyl-s-indacen-1-yl]silanaminato(2-)-N]titanium (0.4970 g, 0.001039 moles) was stirred in diethylether (50 mL) as MeMgBr (0.0021 moles, 0.70 mL of 3.0 M solution in diethylether) was added slowly. This mixture was then stirred for 1 hour. After the reaction period the volatiles were removed and the residue extracted and filtered using hexane. Removal of the hexane resulted in the isolation of the desired product as a golden yellow solid (0.4546 g, 66.7% yield).

¹H NMR (C₆D₆): d0.071 (s, 3H), 0.49 (s, 3H), 0.70 (s, 3H), 0.73 (s, 3H), 1.49 (s, 9H), 1.7-1.8 (m, 2H), 2.5-2.8 (m, 4H), 6.41 (s, 1H), 7.29 (t, ³J_{HH}=7.4 Hz, 2H), 7.48 (s, 1H), 7.72 (d, ³J_{HH}=7.4 Hz, 2H), 7.92 (s, 1H).

¹³C NMR (C₆D₆) d2.19, 4.61, 27.12, 32.86, 33.00, 34.73, 58.68, 58.82, 118.62, 121.98, 124.26, 127.32, 128.63, 128.98, 131.23, 134.39, 136.38, 143.19, 144.85.

Preparation of Catalyst B:(1H-cyclopenta[l]phenanthrene-2-yl)dimethyl(t-butylamido)-silanetitanium 1,4-diphenylbutadiene)

1) Preparation of Lithium 1H-cyclopenta[l]phenanthrene-2-yl

To a 250 ml round bottom flask containing 1.42 g (0.00657 mole) of 1H-cyclopenta[l]phenanthrene and 120 ml of benzene are added dropwise, 4.2 ml of a 1.60 M solution of n-BuLi in mixed hexanes. The solution is allowed to stir overnight. The lithium salt is isolated by filtration, washing twice with 25 ml benzene and drying under vacuum. Isolated yield is 1.426 g (97.7 percent). ¹H NMR analysis indicates the predominant isomer is substituted at the 2 position.

2) Preparation of (1H-cyclopenta[l]phenanthrene-2-yl)dimethyl-chlorosilane

To a 500 ml round bottom flask containing 4.16 g (0.0322 mole) of dimethyldichlorosilane (Me₂SiCl₂ ) and 250 ml of tetrahydrofuran (THF) is added dropwise a solution of 1.45 g (0.0064 mole) of lithium 1H-cyclopenta[l]phenanthrene-2-yl in THF. The solution is stirred for approximately 16 hours, after which the solvent is removed under reduced pressure, leaving an oily solid which is extracted with toluene, filtered through diatomaceous earth filter aid (Celite™), washed twice with toluene and dried under reduced pressure. Isolated yield is 1.98 g (99.5 percent).

3) Preparation of (1H-cyclopenta[l]phenanthrene-2-yl)dimethyl(t-butylamino)silane

To a 500 ml round bottom flask containing 1.98 g (0.0064 mole) of (1H-cyclopenta[l]phenanthrene-2-yl)dimethylchlorosilane and 250 ml of hexane is added 2.00 ml (0.0160 mole) of t-butylamine. The reaction mixture is allowed to stir for several days, then filtered using diatomaceous earth filter aid (Celite™), washed twice with hexane. The product is isolated by removing residual solvent under reduced pressure. The isolated yield is 1.98 g (88.9 percent).

4) Preparation of dilithio (1H-cyclopenta[l]phenanthrene-2-yl)di-methyl(t-butylamido)silane

To a 250 ml round bottom flask containing 1.03 g (0.0030 mole) of (1H-cyclopenta[l]phenanthrene-2-yl)dimethyl(t-butylamino)silane) and 120 ml of benzene is added dropwise 3.90 ml of a solution of 1.6 M n-BuLi in mixed hexanes. The reaction mixture is stirred for approximately 16 hours. The product is isolated by filtration, washed twice with benzene and dried under reduced pressure. Isolated yield is 1.08 g (100 percent).

5) Preparation of (1H-cyclopenta[l]phenanthrene-2-yl)dimethyl(t-butylamido)silanetitanium Dichloride

To a 250 ml round bottom flask containing 1.17 g (0.0030 mole) of TiCl₃.3THF and about 120 ml of THF is added at a fast drip rate about 50 ml of a THF solution of 1.08 g of dilithio (1H-cyclopenta[l]phenanthrene-2-yl)dimethyl(t-butylamido)silane. The mixture is stirred at about 20° C. for 1.5 hours at which time 0.55 gm (0.002 mole) of solid PbCl₂ is added. After stirring for an additional 1.5 hours the THF is removed under vacuum and the residue is extracted with toluene, filtered and dried under reduced pressure to give an orange solid. Yield is 1.31 g (93.5 percent).

6) Preparation of (1H-cyclopenta[l]phenanthrene-2-yl)dimethyl(t-butylamido)silanetitanium 1,4-diphenylbutadiene

To a slurry of (1H-cyclopenta[l]phenanthrene-2-yl)dimethyl(t-butylamido)silanetitanium dichloride (3.48 g, 0.0075 mole) and 1.551 gm (0.0075 mole) of 1,4-diphenyllbutadiene in about 80 ml of toluene at 70° C. are added 9.9 ml of a 1.6 M solution of n-BuLi (0.0150 mole). The solution immediately darkens. The temperature is increased to bring the mixture to reflux for 2 hrs. The mixture is cooled to about −20° C. and the volatiles are removed under reduced pressure. The residue is slurried in 60 ml of mixed hexanes at about 20° C. for approximately 16 hours. The mixture is cooled to about −25° C. for about 1 hour. The solids are collected on a glass frit by vacuum filtration and dried under reduced pressure. The dried solid is placed in a glass fiber thimble and solid extracted continuously with hexanes using a soxhlet extractor. After 6 hours a crystalline solid is observed in the boiling pot. The mixture is cooled to about −20° C., isolated by filtration from the cold mixture and dried under reduced pressure to give 1.62 g of a dark crystalline solid. The filtrate is discarded. The solids in the extractor are stirred and the extraction continued with an additional quantity of mixed hexanes to give an additional 0.46 gm of the desired product as a dark crystalline solid.

D) Polymerization for ESI-1

ESI-1 was prepared in a 6 gallon (22.7 L), oil jacketed, Autoclave continuously stirred tank reactor (CSTR). A magnetically coupled agitator with Lightning A-320 impellers provided the mixing. The reactor ran liquid full at 475 psig (3,275 kPa). Process flow was in at the bottom and out of the top. A heat transfer oil was circulated through the jacket of the reactor to remove some of the heat of reaction. At the exit of the reactor was a micromotion flow meter that measured flow and solution density. All lines on the exit of the reactor were traced with 50 psi (344.7 kPa) steam and insulated.

Toluene solvent was supplied to the reactor at 30 psig (207 kPa). The feed to the reactor was measured by a Micro-Motion mass flow meter. A variable speed diaphragm pump controlled the feed rate. At the discharge of the solvent pump, a side stream was taken to provide flush flows for the catalyst injection line (1 lb/hr (0.45 kg/hr)) and the reactor agitator (0.75 lb/hr (0.34 kg/hr)). These flows were measured by differential pressure flow meters and controlled by manual adjustment of micro-flow needle valves. Uninhibited styrene monomer was supplied to the reactor at 30 psig (207 kpa). The feed to the reactor was measured by a Micro-Motion mass flow meter. A variable speed diaphragm pump controlled the feed rate. The styrene stream was mixed with the remaining solvent stream.

Ethylene was supplied to the reactor at 600 psig (4,137 kPa). The ethylene stream was measured by a Micro-Motion mass flow meter just prior to the Research valve controlling flow. A Brooks flow meter/controller was used to deliver hydrogen into the ethylene stream at the outlet of the ethylene control valve. The ethylene/hydrogen mixture combines with the solvent/styrene stream at ambient temperature. The temperature of the solvent/monomer as it enters the reactor was dropped to ˜5° C. by an exchanger with −5° C. glycol on the jacket. This stream entered the bottom of the reactor.

The three component catalyst system and its solvent flush also entered the reactor at the bottom but through a different port than the monomer stream. Preparation of the catalyst components took place in an inert atmosphere glove box. The diluted components were put in nitrogen padded cylinders and charged to the catalyst run tanks in the process area. From these run tanks the catalyst was pressured up with piston pumps and the flow was measured with Micro-Motion mass flow meters. These streams combine with each other and the catalyst flush solvent just prior to entry through a single injection line into the reactor.

Polymerization was stopped with the addition of catalyst kill (water mixed with solvent) into the reactor product line after the micromotion flow meter measuring the solution density. Other polymer additives can be added with the catalyst kill. A static mixer in the line provided dispersion of the catalyst kill and additives in the reactor effluent stream. This stream next entered post reactor heaters that provide additional energy for the solvent removal flash. This flash occurred as the effluent exited the post reactor heater and the pressure was dropped from 475 psig (3,275 kPa) down to ˜250 mm of pressure absolute at the reactor pressure control valve. This flashed polymer entered a hot oil jacketed devolatilizer. Approximately 85 percent of the volatiles were removed from the polymer in the devolatilizer. The volatiles exited the top of the devolatilizer. The stream was condensed with a glycol jacketed exchanger and entered the suction of a vacuum pump and was discharged to a glycol jacket solvent and styrene/ethylene separation vessel. Solvent and styrene were removed from the bottom of the vessel and ethylene from the top. The ethylene stream was measured with a Micro-Motion mass flow meter and analyzed for composition. The measurement of vented ethylene plus a calculation of the dissolved gasses in the solvent/styrene stream were used to calculate the ethylene conversion. The polymer separated in the devolatilizer was pumped out with a gear pump to a ZSK-30 devolatilizing vacuum extruder. The dry polymer exits the extruder as a single strand. This strand was cooled as it was pulled through a water bath. The excess water was blown from the strand with air and the strand was chopped into pellets with a strand chopper.

E) ESI-2 Polymerization

ESI-2 was prepared in a continuously operating loop reactor (36.8 gal). An Ingersoll-Dresser twin screw pump provides the mixing. The reactor is run liquid full at 475 psig (3,275 kPa) with a residence time of approximately 25 minutes. Raw materials and catalyst/cocatalyst flows are fed into the suction of the twin screw pump through injectors and Kenics static mixers. The twin screw pump discharges into a 2″ diameter line which supplies two Chemineer-Kenics 10-68 type BEM Multi-Tube heat exchangers in series. The tubes of these exchangers contains twisted tapes to increase heat transfer. Upon exiting the last exchanger, loop flow returns through the injectors and static mixers to the suction of the pump. Heat transfer oil is circulated through the exchanger jackets to control the loop temperature probe located just prior to the first exchanger. The exit stream of the loop reactor is taken off between the two exchangers. The flow and solution density of the exit stream is measured by a MicroMotion flowmeter.

Solvent feed to the reactor is supplied by two different sources. A fresh stream of toluene from an 8480-S-E Pulsafeeder diaphragm pump with rates measured by a MicroMotion flowmeter is used to provide flush flow for the reactor seals (20 lb. (9.1 kg)/hr). Recycle solvent is mixed with uninhibited styrene monomer on the suction side of five 8480-5-E Pulsafeeder diaphragm pumps in parallel. These five Pulsafeeder pumps supply solvent and styrene to the reactor at 650 psig (4,583 kPa). Fresh styrene flow is measured by a MicroMotion flowmeter and total recycle solvent/styrene flow is measured by a separate MicroMotion flowmeter. Ethylene is supplied to the reactor at 687 psig (4,838 kPa). The ethylene stream is measured by a MicroMotion mass flowmeter. A Brooks flowmeter/controller is used to deliver hydrogen into the ethylene stream at the outlet of the ethylene control valve. The ethylene/hydrogen mixture combines with the solvent/styrene stream at ambient temperature. The temperature of the entire feed stream as it enters the reactor loop is lowered to 2° C. by an exchanger with −10° C. glycol on the jacket. Preparation of the three catalyst components takes place in three separate tanks: fresh solvent and concentrated catalyst/cocatalyst premix are added and mixed into their respective run tanks and fed into the reactor via variable speed 680-S-AEN7 Pulsafeeder diaphragm pumps. As previously explained, the three component catalyst system enters the reactor loop through an injector and static mixer into the suction side of the twin screw pump. The raw material feed stream is also fed into the reactor loop through an injector and static mixer downstream of the catalyst injection point but upstream of the twin screw pump suction.

Polymerization is stopped with the addition of catalyst kill (water mixed with solvent) into the reactor product line. A static mixer in the line provides dispersion of the catalyst kill and additives in the reactor effluent stream. This stream next enters post reactor heaters that provide additional energy for the solvent removal flash. This flash occurs as the effluent exits the post reactor heater and the pressure is dropped from 475 psig (3,275 kPa) down to 450 mmHg (60 kPa) of absolute pressure at the reactor pressure control valve. This flashed polymer enters the first of two hot oil jacketed devolatilizers. The volatiles flashing from the first devolatizer are condensed with a glycol jacketed exchanger, passed through the suction of a vacuum pump, and discharged to the solvent and styrene/ethylene separation vessel. Solvent and styrene are removed from the bottom of this vessel as recycle solvent while ethylene exhausts from the top. The ethylene stream is measured with a MicroMotion mass flowmeter. The measurement of vented ethylene plus a calculation of the dissolved gases in the solvent/styrene stream are used to calculate the ethylene conversion. The polymer and remaining solvent separated in the devolatilizer are pumped with a gear pump to a second devolatizer. The pressure in the second devolatizer is operated at 5 mmHg (0.7 kPa) absolute pressure to flash the remaining solvent. This solvent is condensed in a glycol heat exchanger, pumped through another vacuum pump, and exported to a waste tank for disposal. The dry polymer (<1000 ppm total volatiles) is pumped with a gear pump to an underwater pelletizer with 6-hole die, pelletized, spin-dried, and collected in 1000 lb boxes.

TABLE 1
Preparation Conditions for ESI Resins

| | Reactor | Solvent | Ethylene | Hydrogen | Styrene | Ethylene | | | | |
|---|---|---|---|---|---|---|---|---|---|---|
| | Temp | Flow | Flow | Flow | Flow | Conversion | B/Ti | MMAO^{d}/ | | Co- |
| ESI # | ° C. | lb/hr | Lb/hr | sccm | lb/hr | percent | Ratio | Ti Ratio | Catalyst | Catalyst |
| ESI-1 | 93.1 | 37.9 | 3.1 | 13.5 | 6.9 | 96.1 | 2.99 | 7.0 | A^{a} | C^{c} |
| ESI-2 | 88.0 | 590 | 55 | 250 | 133 | 94 | 3.5 | 4.9 | B^{b} | C^{c} |

^{a}Catalyst A is dimethyl[N-(1,1 -dimethylethyl)-1,1-dimethyl-1-[(1,2,3,4,5-η)-1,5,6,7-tetrahydro-3-phenyl-s-indacen-1-yl]silanaminato(2-)-N]-titanium.
^{b}Catalyst B is ;(1H-cyclopenta[1]phenanthrene-2-yl)dimethyl(t-butylamido)-silanetitanium 1,4-diphenylbutadiene)
^{c}Cocatalyst C is tris(pentafluorophenyl)borane, (CAS# 001109-15-5),.
^{d}a modified methylaluminoxane commercially available from Akzo Nobel as MMAO-3A (CAS# 146905-79-5)

TABLE 2
Properties of ESI Resins.

| | weight. | | aPS | | |
|---|---|---|---|---|---|
| | percent | Mol. percent | weight | Melt Index, | |
| | Copolymer | Copolymer | per- | I₂ | Gottfert # |
| ESI | Styrene | Styrene | cent | (g/10 min) | (cm³/10 min) |
| ESI-1 | 47.4 | 19.5 | 0.5 | | 1.4 |
| ESI-2 | 44.6 | 17.8 | 11 | 1.5 | |

II. Foam Preparation A foam suitable for use in the present invention is made using a screw type extruder having a feeding zone, a metering, a mixing zone, heating zones, and cooling zones. A rectangular shaped die is mounted at the end of the cooling zones.

### EXAMPLES 1-11 AND COMPARATIVE EXAMPLES A AND B

Using a foam apparatus comprising a single screw extruder, mixer, coolers and foaming die, prepare foam product from the compositions shown in Tables 3 and 4 at foaming temperatures shown in Tables 3 and 4. In Table 4, Comparative Example B includes HYDROCEROL™ CF40E (Boehringer Ingelheim) as nucleator, and 0.5 phr of glycerol monostearate permeability modifier and all samples use 0.06 phr of IRGANOX™ 1010 (Ciba) antioxidant, all amounts being based on 100 parts by weight of total polymer weight. Subject resulting foams to physical property testing as shown in Tables 3 and 4.

Make density, open-cell content, cell size, compressive strength (at 10%, 25% and 50% compression), and compression set measurements in accordance with ASTM Test Method Nos. D3575-93 (Suffix W, Method B), D2856-94, D2856-94, D3573-93 (Suffix B), and DIN 53572, respectively. Measure dynamic cushioning C-factors in accordance with ASTM D 1596. Measure compressive recovery by compressing the foam by 90% of its original thickness, releasing the load and measuring the recovery after 24 hours. Isobutane % shows the isobutane content (wt %) of the foams after 28 days.

Dimensional stability is shown in Table 3 as the maximum volume change at 23° C. over a 7-day period. This is the difference between the lowest volume over the 7-day period and starting volume. A negative number means the foam shrinks. Dimensional stability is shown in Table 4 as density range measured over time. As the foam shrinks, the density increases and as the foam expands, the density decreases. Density range refers to the maximum density value minus the minimum density value over a 70-day period.

Examples 1 to 6 show that blends of the present invention readily provide dimensionally stable foams without the use of permeability modifiers, unlike the extruded LDPE foam which exhibited a maximum volume change as high as −28.5 volume percent.

In Table 4, the foams of the invention (examples 7 to 11) show a narrow range in density over time. Therefore, these foams have dimensional stability properties comparable to or better than the comparative LDPE foam made with GMS as permeability modifier, but do not require the use of permeability modifying additives to be dimensionally stable.

Even when permeability modifier is absent, the change in density and the maximum volume change at room temperature is minimal. This shows that blends of the present invention provide dimensionally stable foams even in the absence of permeability modifiers. The Asker C hardness of the foams is 30 or less.

As shown by the data in Tables 3 and 4, the foaming temperature window with PS/LDPE/ESI blends is as wide as 4° C. (for a specific composition), much larger than a typical 1° C. or smaller foaming window for LDPE. Consequently, the open cell contents of the foams of the invention could be varied from 29.7 to 53.4 volume percent (examples 3 to 6 in Table 3) and 23.5 to 74.1 volume percent (examples 7 to 11 in Table 4) with only small changes in foam density. In comparison, extruded LDPE foams typically have an upper open cell content limit of about 20 volume percent since the viscosity drops rapidly as the foaming temperature exceeds the crystalline melting point of LDPE, leading to foam collapse after the die.

Comparing foam example 11 with comparative foam example B in Table 4, both of which had similar amounts of open cells and were expanded with the same amount of blowing agent, it is clear that the PS/LDPE/ESI blend resulted in significantly lower foam density with the other properties (compressive strength, compression set, compressive recovery and 1st drop C-factor) being essentially similar. Reduced foam density is a significant benefit for economic (lower cost) and environmental (reduced waste) reasons.

1st drop C-factor is a measure of dynamic cushioning properties and is calculated at the static load corresponding to the lowest G-values using the formula: C=(G-value×Thickness of Foam)/(Drop Height) where the G-value is determined according to ASTM D1596 by dropping a load on foam after aging the foam for 28 days at room temperature.

The foams of the present invention (examples 7 to 11 in Table 4) also cured faster than the reference LDPE foam (comparative example B in Table 4), as evident from the isobutane content measured after 28 days aging at 23° C.

TABLE 3

| | | Examples | | | | | |
|---|---|---|---|---|---|---|---|
| | Comp Ex A | 1 | 2 | 3 | 4 | 5 | 6 |
| Polymers (wt%) | | | | | | | |
| PS (192,000 Mw) | | 20 | 40 | 40 | 40 | 40 | 40 |
| LDPE (1.8 | 100 | 60 | 40 | 40 | 40 | 40 | 40 |
| dg/min I2) | | | | | | | |
| ESI-1 | | 20 | 20 | 20 | 20 | 20 | 20 |
| Blowing Agent | | | | | | | |
| (phr) | | | | | | | |
| isobutane | 7.5 | 10 | 7.5 | 10 | 10 | 10 | 10 |
| Foaming Temp. | 112 | 104 | 110 | 112 | 110 | 109 | 108 |
| (° C.) | | | | | | | |
| Properties | | | | | | | |
| Density (kg/m³) | 37.7 | 70.2 | 104.8 | 43.0 | 43.3 | 39.9 | 39.8 |
| Open cell | 4.5 | 45.1 | 58.3 | 29.7 | 36.6 | 48.8 | 53.4 |
| (volume percent) | | | | | | | |
| Cell size (mm) | 1.63 | 0.07 | 0.65 | 0.96 | 0.86 | 0.90 | 0.96 |
| Maximum | −28.5 | −1.3 | −1.6 | −2.6 | −2.9 | −2.4 | −2.5 |
| Volume Change | | | | | | | |
| at 23° C. (%) | | | | | | | |

TABLE 4

| | | Examples | | | | |
|---|---|---|---|---|---|---|
| | Comp Ex B | 7 | 8 | 9 | 10 | 11 |
| Polymers (wt %) | | | | | | |
| PS (192,000 Mw) | | 40 | 40 | 40 | 40 | 40 |
| LDPE (0.7 I2 and 0.923 | | 40 | 40 | 40 | 40 | 40 |
| g/cm³ density) | | | | | | |
| LDPE (2.4 I2 and 0.924 | 100 | | | | | |
| g/cm³ density) | | | | | | |
| ESI-2 | | 20 | 20 | 20 | 20 | 20 |
| Additives (phr) | | | | | | |
| isobutane | 10 | 10 | 10 | 10 | 10 | 10 |
| Glycerol monostearate | 0.5 | | | | | |
| (GMS) | | | | | | |
| Antioxidant | 0.06 | 0.06 | 0.06 | 0.06 | 0.06 | 0.06 |
| Nucleator | 0.2 | | | | | |
| Foaming Temp. (° C.) | 111 | 112 | 111 | 110 | 109 | 108 |
| Properties | | | | | | |
| Width (mm): fresh | 146 | 148 | 153 | 163 | 165 | 180 |
| Thickness (mm): fresh | 21 | 21 | 23 | 22 | 22 | 22 |
| Density (kg/m³): fresh | 31.4 | 35.3 | 28.4 | 28.5 | 27.8 | 27.6 |
| Density (kg/m³): 1 day | 31.0 | | | | | |
| Density (kg/m³): 3 days | 30.5 | | | | | |
| Density (kg/m³): 4 days | | 35.0 | 28.6 | 27.8 | 27.3 | 27.1 |
| Density (kg/m³): 7 days | 29.7 | | | | | |
| Density (kg/m³): 8 days | | 36.0 | 27.5 | 27.8 | 27.8 | 27.1 |
| Density (kg/m³): 14 days | 30.0 | 35.9 | 27.7 | 28.0 | 27.5 | 27.2 |
| Density (kg/m³): 28 days | 29.7 | 37.0 | 28.6 | 28.6 | 27.0 | 26.9 |
| Density (kg/m³): 70 days | 29.8 | 35.8 | 27.6 | 27.7 | 26.9 | 26.7 |
| Open cell (volume percent) | 17.7 | 74.1 | 65.1 | 39.0 | 26.7 | 23.5 |
| Density range (kg/m³) | 1.7 | 2.0 | 1.1 | 0.9 | 1.1 | 0.9 |
| Hardness (Asker C) | 28 | 27 | 28 | 30 | 29 | 29 |
| 3D average cell size (mm) | 1.23 | 0.94 | 1.22 | 1.15 | 1.31 | 1.24 |
| 10% 3D average | 35 | 44 | | 33 | | 37 |
| compressive strength (kPa): | | | | | | |
| 28 days | | | | | | |
| 25% 3D average | 63 | 55 | | 51 | | 56 |
| compressive strength (kPa): | | | | | | |
| 28 days | | | | | | |
| 50% 3D average | 104 | 62 | | 74 | | 88 |
| compressive strength (kPa): | | | | | | |
| 28 days | | | | | | |
| 24 hr compression set (%): | 5.2 | 4.6 | | 7.0 | | 7.0 |
| 28 days | | | | | | |
| Compressive recovery, 24 | 97.2 | 92.6 | | 94.3 | | 96.7 |
| hr: 28 days | | | | | | |
| 1st drop C-factor: 28 days | 3.5 | | | | | 3.6 |
| Isobutane Content (wt %): | 0.6 | 0.0 | 0.0 | 0.2 | 0.3 | 0.3 |
| 28 days | | | | | | |

What is claimed is:

1. A soft, dimensionally stable foam comprising
(A) from about 25 to about 75% by weight (based on the combined weight of Components A, B and C) of one or more alkenyl aromatic polymers;
(B) from about 25 to about 75% by weight (based on the combined weight of Components A, B and C) of one or more ethylene and/or C₃-C₂₀ α-olefin homopolymers or copolymers; and
(C) from about 5 to about 50% by weight (based on the combined weight of Components A, B and C) of one or more substantially random interpolymers; comprising;
(1) from about 5 to about 65 mole percent of polymer units derived from;
(a) at least one vinyl or vinylidene aromatic monomer, or
(b) at least one hindered aliphatic or cycloaliphatic vinyl or vinylidene monomer, or
(c) a combination of at least one aromatic vinyl or vinylidene monomer and at least one hindered aliphatic or cycloaliphatic vinyl or vinylidene monomer, and
(2) from about 35 to about 95 mole percent polymer units derived from at least one of ethylene and/or a C3-20 α-olefin; and
(4) optionally, polymer units derived from one or more of ethylenically unsaturated polymerizable monomers other than those derived from (1) and (2); and wherein
said soft foam has a density of from about 5 to about 110 kg per cubic meter and an Asker C hardness of less than about 65.

2. The soft, dimensionally stable foam of claim 1 wherein
A) in Component (A), said at least one alkenyl aromatic polymer has greater than 50 percent by weight alkenyl aromatic monomeric units, has a molecular weight (M_{w}) of from about 60,000 to about 350,000 and is present in an amount of from about 30 to about 70 percent by weight (based on the combined weight of Components A, B and C);
B) from about 30 to about 70% by weight (based on the combined weight of Components A, B and C) of one or more ethylene and/or C₃-C₈ α-olefin homopolymers or copolymers; and
C) said substantially random interpolymer, Component (C) is present in an amount of from about 7 to about 45 percent by weight (based on the combined weight of Components A, B and C); and comprises
(1) from about 7 to about 50 mol % of polymer units derived from;
(a) said vinyl or vinylidene aromatic monomer represented by the following formula; 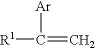
wherein R¹ is selected from the group of radicals consisting of hydrogen and alkyl radicals containing three carbons or less, and Ar is a phenyl group or a phenyl group substituted with from 1 to 5 substituents selected from the group consisting of halo, C₁₋₄-alkyl, and C₁₋₄-haloalkyl; or
(b) said sterically hindered aliphatic or cycloaliphatic vinyl or vinylidene monomer is represented by the following general formula; 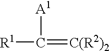
wherein A¹ is a sterically bulky, aliphatic or cycloaliphatic substituent of up to 20 carbons, R¹ is selected from the group of radicals consisting of hydrogen and alkyl radicals containing from 1 to about 4 carbon atoms, preferably hydrogen or methyl; each R² is independently selected from the group of radicals consisting of hydrogen and alkyl radicals containing from 1 to about 4 carbon atoms, preferably hydrogen or methyl; or alternatively R¹ and A¹ together form a ring system; or
c) a combination of a and b; and
(2) from about 50 to about 93 mol % of polymer units derived from ethylene and/or said α-olefin which comprises at least one of propylene, 4-methyl-1-pentene, butene-1, hexene-1 or octene-1; and
(3) said ethylenically unsaturated polymerizable monomers other than those derived from (1) and (2) are present in an amount of from 0 to about 30 mol percent and comprise norbornene, or a C₁₋₁₀ alkyl or C₆₋₁₀ aryl substituted norbornene; and wherein said soft foam has a density of from about 10 to about 80 kg per cubic meter and an Asker C hardness of less than about 60.

3. The soft, dimensionally stable foam of claim 1 wherein
A) in Component (A), said at least one alkenyl aromatic polymer has greater than 50 percent by weight alkenyl aromatic monomeric units, has a molecular weight (M_{w}) of from about 100,000 to about 300,000 and is present in an amount of from about 35 to about 65 percent by weight (based on the combined weight of Components A, B and C);
B) from about 30 to about 65% by weight (based on the combined weight of Components A, B and C) of one or more homopolymers of ethylene or propylene and interpolymers of ethylene with a C₃-C₈ α-olefin; and
C) said substantially random interpolymer, Component (C) is present in an amount of from about 10 to about 40 percent by weight (based on the combined weight of Components A, B and C); and comprises
(1) from about 10 to about 45 mol % of polymer units derived from;
a) said vinyl aromatic monomer which comprises styrene, α-methyl styrene, ortho-, meta-, and para-methylstyrene, and the ring halogenated styrenes, or
b) said aliphatic or cycloaliphatic vinyl or vinylidene monomers which comprises 5-ethylidene-2-norbornene or 1-vinylcyclo-hexene, 3-vinylcyclo-hexene, and 4-vinylcyclohexene; or
c) a combination of a and b; and
(2) from about 55 to about 90 mol % of polymer units derived from ethylene and/or said α-olefin which comprises at least one of propylene, 4-methyl-1-pentene, butene-1, hexene-1 or octene-1; and
(3) said ethylenically unsaturated polymerizable monomers other than those derived from (1) and (2) are present in an amount of from 0 to about 20 mol percent and comprise norbornene, or a C₁₋₁₀ alkyl or C₆₋₁₀ aryl substituted norbornene; and wherein
said soft foam has a density of from about 10 to about 60 kg per cubic meter and an Asker C hardness of less than about 50.

4. The soft, dimensionally stable foam of claim 1 wherein said alkenyl aromatic homopolymer or copolymer, Component (A), is derived from styrene, Component B is selected from the group consisting of LDPE, polypropylene and ethyl vinylacetate copolymer, and Component (C) is a substantially random interpolymer of ethylene and styrene.

5. The soft, dimensionally stable foam of claim 1 wherein said alkenyl aromatic homopolymer or copolymer, Component (A), is derived from styrene, Component B is selected from the group consisting of LDPE, polypropylene and ethyl vinylacetate copolymer and, Component (C) is a substantially random interpolymer of ethylene, propylene and styrene.

6. The soft, dimensionally stable foam of claims 1-5 wherein the foam is prepared without a permeability modifier.

7. The foam of claims 1-6 having a multiplicity of channels extending from a surface into the foam, the channels being free of direction with respect to the longitudinal extension of the foam.

8. Use of the soft dimensionally stable foam of claims 1-7 as cushion packaging.

9. A process for making an extruded soft, dimensionally stable foam, which process comprises;
(I) forming a melt polymer material comprising;
(A) from about 25 to about 75% by weight (based on the combined weight of Components A, B and C) of one or more alkenyl aromatic polymers;
(B) from about 25 to about 75% by weight (based on the combined weight of Components A, B and C) of one or more ethylene and/or C₃-C₂₀ α-olefin homopolymers or copolymers; and
(C) from about 5 to about 50% by weight (based on the combined weight of Components A, B and C) of one or more substantially random interpolymers; comprising;
(1) from about 5 to about 65 mole percent of polymer units derived from;
(a) at least one vinyl or vinylidene aromatic monomer, or
(b) at least one hindered aliphatic or cycloaliphatic vinyl or vinylidene monomer, or
(c) a combination of at least one aromatic vinyl or vinylidene monomer and at least one hindered aliphatic or cycloaliphatic vinyl or vinylidene monomer, and
(2) from about 35 to about 95 mole percent polymer units derived from at least one of ethylene and/or a C₃₋₂₀ α-olefin; and
optionally, polymer units derived from one or more of ethylenically unsaturated polymerizable monomers other than those derived from (1) and (2);
(II) incorporating into said melt polymer material at an elevated pressure to form a foamable gel
(E) one or more blowing agents present in a total amount of from about 0.4 to about 5.0 gram-moles per kilogram (based on the combined weights of Component A B and C);
(III) cooling said foamable gel to an optimum temperature; and
(5) extruding the gel from Step III through a die to a region of lower pressure to form a foam; and wherein
said soft foam has a density of from about 5 to about 110 kg per cubic meter and an Asker C hardness of less than about 65.
